(19) United States
(12) Patent Application Publication
(10) Pub. No.: US 2015/0146130 A1
(43) Pub. Date: May 28, 2015

(54) Liquid Crystal Display Panel and Manufacturing Method for the Same

(71) Applicant: Shenzhen China Star Optoelectronics Technology Co. Ltd., Shenzhen (CN)

(72) Inventors: Shyfeng Chen, Shenzhen (CN); Jehao Hsu, Shenzhen (CN); Ming-Hung Shih, Shenzhen (CN); Zenghua Li, Shenzhen (CN)

(73) Assignee: Shenzhen China Star Optoelectronics Technology Co., Ltd., Shenzhen (CN)

(21) Appl. No.: 13/805,965

(22) PCT Filed: Nov. 14, 2012
(86) PCT No.: PCT/CN2012/084554

§ 371 Date: Dec. 20, 2012

(30) Foreign Application Priority Data
Aug. 9, 2012 (CN) 201210281647.7

(51) Int. Cl. G02F 1/1339; G02F 1/1335; G02F 1/1368; G02F 1/1333

(52) U.S. Cl. CPC G02F 1/1339; G02F 1/133308; G02F 1/133514; G02F 1/133512; G02F 1/1368
USPC 349/58; 445/25

(57) ABSTRACT

The present invention discloses a liquid crystal display (LCD) panel which includes a thin film transistor array substrate, a color filter substrate, a liquid crystal layer and a frame. The color filter substrate includes a transparent substrate, a black matrix layer and a coloring layer. The frame is disposed at an outer side edge of the liquid crystal layer. The present invention further discloses a method for manufacturing the LCD panel. The present invention can block an UV light by the black matrix layer and the coloring layer, and an UV mask can be omitted.

### BACKGROUND OF THE INVENTION

1. Field of the Invention

The present invention relates to a field of liquid crystal display panel technology, and more particularly, to a liquid crystal display panel and a manufacturing method for the same.

2. Description of the Prior Art

A curing process of sealants is required in a process for manufacturing a liquid crystal display (LCD) panel. Please refer to FIG. 1, a traditional curing technique of the sealants 207 is that: a thin film transistor (TFT) array substrate 202 of the LCD panel is faced to an ultraviolet (UV) light 10; then, an UV mask 201 is disposed between the TFT array substrate 202 and the UV light 10; then, the sealants 207 is irradiated by the UV light 10 at a side of the TFT array substrate 202; and then an active area within the LCD panel is blocked by the UV mask 201.

The sealants 207 are irradiated by the UV light 10 in order to cure the sealants 207. The active area is blocked by the UV mask 201 in order to avoid that liquid crystal molecules within a liquid crystal layer 203 are damaged by the UV light 10. For a LCD device of a polymer sustained vertical alignment (PSVA) mode, the active area is blocked by the UV mask 201 that can also prevent that materials which have formation of a pre-tilt angle within the LCD device is early cured.

However, since the UV mask 201 is disposed between the TFT array substrate 202 and the UV light 10, and therefore there are a certain distance L1 between a flat of the UV mask 201 and a flat of the liquid crystal layer 203 of the LCD panel. In a state for fixing values of the certain distance L1, a distance L2 between an outer side edge of the UV mask 201 and an outer side edge of the liquid crystal layer 203 is required to have a minimum, that is, the distance L2 cannot be less than the minimum, otherwise the liquid crystal layer 203 will be irradiated by the UV light 10.

When a frame of the LCD panel is made into a narrow frame, a traditional technical scheme is that the sealants 207 and a distance L3 of an outer side edge of the active area are reduced, thus minimizing the distance L3. In this case, that can make the distance L3 be as small as possible, as well as the sealants 207 be irradiated by the UV light 10, and the liquid crystal layer 203 not be irradiated by the UV light 10. Therefore, a technical scheme which the UV mask 201 is disposed between the TFT array substrate 202 and the UV light 10 cannot solve the problem of curing the sealants 207, as well as prevent the problem of damaging liquid crystals.

Moreover, if the UV mask 201 is applied to the process for manufacturing the LCD panel, the UV mask is needed to manufacture in accordance with an actually used product. Furthermore, in the process for manufacturing the LCD panel, the UV mask 201 is needed to exactly locate on the LCD panel, and otherwise the above object will not be achieved. The above technical scheme is to enable the LCD panel having higher manufacturing costs, as well as to complicate the process for manufacturing the LCD panel.

Therefore, there is a need to provide a new technical scheme, so as to overcome the above-mentioned disadvantages.

### SUMMARY OF THE INVENTION

An object of the present invention is to provide a LCD panel. In a process for curing sealants by an UV light, a diaphanous second area is disposed at an edge of a color filter substrate, so that the sealants can be irradiated from a side of the color filter substrate by the UV light. Therefore, an UV mask can be omitted, and liquid crystals within the LCD panel are not damaged, so as to reduce manufacturing costs of the LCD panel, as well as provide a simple process for manufacturing the LCD panel.

To overcome the above-mentioned disadvantages, the present invention provides the LCD panel which includes: a TFT array substrate; the color filter substrate including a transparent substrate, a black matrix (BM) layer and a coloring layer, the transparent substrate having a first surface and a second surface, a first area and a second area being defined on the first surface, the second area being positioned at an outer side of the first area, and the BM layer and the coloring layer being disposed on the first area; a liquid crystal layer disposed between the TFT array substrate and the color filter substrate, and the first surface of the transparent substrate being faced to the liquid crystal layer; and a frame disposed between the TFT array substrate and the color filter substrate, and disposed on a position corresponding to the second area, the liquid crystal layer being adjacent to a surface of the color filter substrate having the BM layer and the coloring layer, and the frame being disposed at an outer side edge of the liquid crystal layer.

In the above LCD panel, the liquid crystal layer is disposed in a region of the first area.

In the above LCD panel, an irradiating region of the UV light on the second surface is greater than or equal to a projecting region of the second area on the second surface.

In the above LCD panel, the TFT array substrate has a third area and a fourth area. The third area is a projection of the liquid crystal layer on the TFT array substrate. The fourth area is positioned at an outer side of the third area, and shading materials are disposed on the fourth area.

Another object of the present invention is to provide a LCD panel. In a process for curing sealants by an UV light, a diaphanous second area is disposed at an edge of a color filter substrate, so that the sealants can be irradiated from a side of the color filter substrate by the UV light. Therefore, an UV mask can be omitted, and liquid crystals within the LCD panel are not damaged, so as to reduce manufacturing costs of the LCD panel, as well as provide a simple process for manufacturing the LCD panel.

To overcome the above-mentioned disadvantages, the present invention provides the LCD panel which includes: a TFT array substrate; the color filter substrate including a transparent substrate, a BM layer and a coloring layer, the transparent substrate having a first surface and a second surface, a first area and a second area being defined on the first surface, the second area being positioned at an outer side of the first area, and the BM layer and the coloring layer being disposed on the first area; a liquid crystal layer disposed between the TFT array substrate and the color filter substrate, and the first surface of the transparent substrate being faced to the liquid crystal layer; and a frame disposed between the TFT array substrate and the color filter substrate, and the frame being disposed between the TFT array substrate and the color filter substrate, and disposed on a position corresponding to the second area.

In the above LCD panel, the liquid crystal layer is disposed in a region of the first area.

In the above LCD panel, an irradiating region of the UV light on the second surface is greater than or equal to a projecting region of the second area on the second surface.

In the above LCD panel, the TFT array substrate has a third area and a fourth area. The third area is a projection of the liquid crystal layer on the TFT array substrate. The fourth area is positioned at an outer side of the third area, and shading materials are disposed on the fourth area.

A further another object of the present invention is to provide a method for manufacturing a LCD panel. In a process for curing sealants by an UV light, a diaphanous second area is disposed at an edge of a color filter substrate, so that the sealants can be irradiated from a side of the color filter substrate by the UV light. Therefore, an UV mask can be omitted, and liquid crystals within the LCD panel are not damaged, so as to reduce manufacturing costs of the LCD panel, as well as provide a simple process for manufacturing the LCD panel.

To overcome the above-mentioned disadvantages, the present invention provides a method for manufacturing the LCD panel. The LCD panel includes a TFT array substrate, the color filter substrate, a liquid crystal layer and a frame. The method includes the following steps of: (A) providing the TFT array substrate; (B) providing the color filter substrate, and the color filter substrate including a transparent substrate, a BM layer and a coloring layer, the transparent substrate having a first surface and a second surface, a first area and a second area being disposed on the first surface, and the BM layer and the coloring layer being disposed on the first area; (C) combining the TFT array substrate, the liquid crystal layer and the color filter substrate, and then disposing the sealants between the TFT array substrate and the color filter substrate, the liquid crystal layer being disposed between the TFT array substrate and the color filter substrate, the second surface of the transparent substrate being faced to the liquid crystal layer, the sealants being disposed between the TFT array substrate and the color filter substrate, and disposed on a position corresponding to the second area; and (D) irradiating the sealants from the second surface of the transparent substrate by the UV light to form the frame.

In a method for manufacturing the above LCD panel, the step (B) further includes the following steps of: (b1) defining the first area and the second area onto the first surface of the transparent substrate, and the second area being positioned at an outer side of the first area; and (b2) forming the BM layer and the coloring layer onto the first area.

In a method for manufacturing the above LCD panel, the step (C) further includes the following steps of: (c1) disposing the liquid crystal layer into a region covered by the first area; and (c2) disposing the sealants between the TFT array substrate and the color filter substrate, and disposed on a position corresponding to the second area.

In a method for manufacturing the above LCD panel, the step (D) further includes the following steps of: (d1) facing the second surface of the transparent substrate to the UV light; (d2) adjusting an irradiating region of the UV light, causing the second area of the transparent substrate to be covered by the irradiating region of the UV light; and (d3) irradiating the transparent substrate by the UV light.

In a method for manufacturing the above LCD panel, the method further includes the following step of: (E) disposing shading materials onto a surface of the TFT array substrate opposite to the liquid crystal layer.

In a method for manufacturing the above LCD panel, the step (E) further includes the following steps of: (e1) defining a third area and a fourth area onto the surface of the TFT array substrate opposite to the liquid crystal layer, and the fourth area being positioned at an outer side of the third area; and (e2) disposing the shading materials onto the fourth area.

The present invention achieved by disposing a diaphanous second area at the side of the color filter substrate, so that the second surface of the transparent substrate of the side of the color filter substrate can be irradiated by the UV light, the second area is covered by the irradiating region of the UV light, and the transparent substrate can be penetrated by the UV light than the prior art. Therefore, the frame disposed on the second area can be irradiated by the UV light, thereby allowing the cure to form the frame, as well as omitting the UV mask. Moreover, since the BM layer and the coloring layer are disposed on the first area, and the BM layer and the coloring layer are close to the liquid crystal layer. Therefore, the BM layer 205 and the coloring layer 204 can be used to block the UV light. Furthermore, since a distance between the coloring layer 204 and the liquid crystal layer 203 is very small, and therefore when the first area is irradiated by the UV light, the UV light irradiated on the first area can be effectively protected (blocked) by the BM layer and the coloring layer, thereby preventing the liquid crystal layer to be irradiated by the UV light. Furthermore, when a narrow frame design of a LCD device is required, since the UV light is blocked by the BM layer and the coloring layer in the process for curing the sealants, and therefore a distance between an outer side of the BM layer and the coloring layer and an outer side of the liquid crystal layer can be made very small. In addition, a distance between the sealants and the outer side of the liquid crystal layer can also be made very small, thereby advantages to achieve the narrow frame in the LCD panel of the present invention. However, since the shading materials are adhered on the TFT array substrate and a position corresponding to the sealants, and therefore a light leak of a backlight can be prevented at the second area, so as to ensure display quality of the LCD panel.

The above objectives, other objectives, features, advantages and embodiments of the present invention will be better understood from the following description being considered in connection with the accompanied drawings and in which a preferred embodiment of the invention is illustrated by way of example.

### BRIEF DESCRIPTION OF THE DRAWINGS

FIG. 1 is a schematic view of a method for curing a frame within a traditional liquid crystal display (LCD) panel;

FIG. 2 is a schematic view of a method according to the present invention for curing a frame within a LCD panel; and

FIGS. 3 and 4 are flow charts of a method according to the present invention for manufacturing the LCD panel.

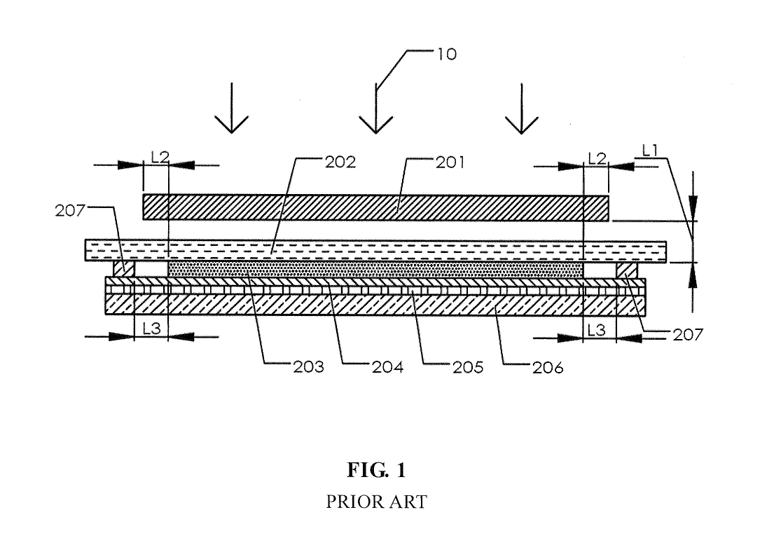

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced.

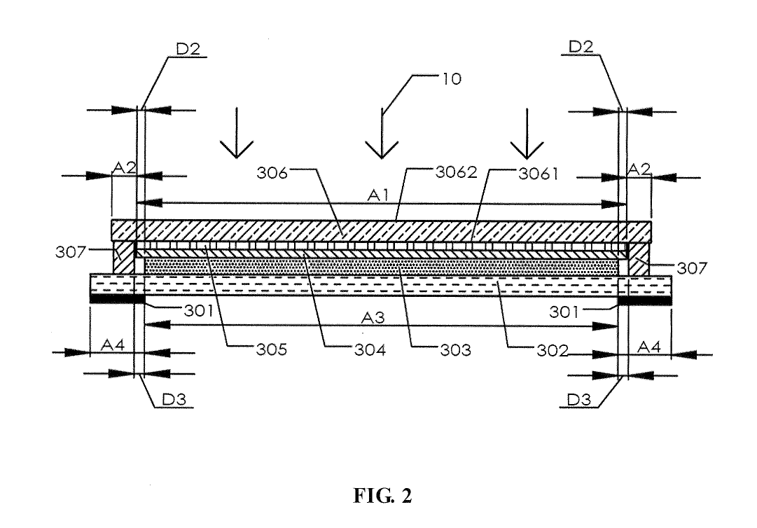

Please refer to FIG. 2. FIG. 2 is a schematic view of a method according to the present invention for curing a frame within a LCD panel. The LCD panel of the present invention includes a TFT array substrate 302, a color filter substrate, a liquid crystal layer 303 and a frame. The color filter substrate includes a transparent substrate 306, a BM layer 305 and a coloring layer 304. The transparent substrate 306 can be a glass substrate. The transparent substrate 306 has a first surface 3061 and a second surface 3062. A first area A1 and a second area A2 are disposed on the first surface 3061. The second area A2 is positioned at an outer side of the first area A1. The BM layer 305 and the coloring layer 304 are disposed on the first area A1. The liquid crystal layer 303 is disposed between the TFT array substrate 302 and the color filter substrate. The first surface 3061 of the transparent substrate 306 is faced to the liquid crystal layer 303, that is, the liquid crystal layer 303 is adjacent to a surface of the color filter substrate having the BM layer 305 and the coloring layer 304. Specifically, the liquid crystal layer 303 is disposed in a region of the first area A1. The frame is disposed between the TFT array substrate 302 and the color filter substrate, and the frame is disposed between the TFT array substrate 302 and the color filter substrate, and disposed on a position corresponding to the second area A2, that is, the frame is disposed at an outer side edge of the liquid crystal layer 303. The sealants 307 are irradiated from the second surface 3062 of the transparent substrate 306 by an UV light 10 to form the frame. An irradiating region of the UV light 10 on the second surface 3062 is greater than or equal to a projecting region of the second area A2 on the second surface 3062. However, since the transparent substrate 306 is transparent, and therefore the UV light 10 is passed through the transparent substrate 306 to the sealants 307.

However, since the second surface 3062 of the transparent substrate 306 is irradiated by the UV light 10, the second area A2 is covered by the irradiating region of the UV light 10, and the transparent substrate 306 can be penetrated by the UV light 10. Therefore, the frame 307 disposed on the second area A2 can be irradiated by the UV light 10, thereby allowing the cure to form the frame, as well as omitting an UV mask 201 in the process. Moreover, since the BM layer 305 and the coloring layer 304 are disposed on the first area A1, and the BM layer 305 and the coloring layer 304 are close to the liquid crystal layer 303. Therefore, the BM layer 305 and the coloring layer 304 can be used to block the UV light. Furthermore, since a distance between the coloring layer 304 and the liquid crystal layer 303 is very small, and therefore when the first area A1 is irradiated by the UV light 10, the UV light 10 irradiated on the first area A1 can be effectively protected (blocked) by the BM layer 305 and the coloring layer 304, thereby preventing the liquid crystal layer 303 to be irradiated by the UV light 10.

When a narrow frame design of a LCD device is required, since the UV light 10 is blocked by the BM layer 305 and the coloring layer 304 in a process for curing the sealants 307, and therefore a distance D2 between an outer side of the BM layer 305 and the coloring layer 304 and an outer side of the liquid crystal layer 303 can be made very small. In addition, a distance D3 between the sealants 307 and the outer side of the liquid crystal layer 303 can also be made very small, thereby advantages to achieve the narrow frame in the LCD panel of the present invention.

In the present invention, in order to prevent a light leak of a backlight at the second area A2, so as to ensure display quality of the LCD panel, and therefore that is need to take a corresponding measures such as that of: a third area A3 and a fourth area A4 are defined on a surface of the TFT array substrate 302 opposite to the liquid crystal layer 303, the third area A3 is a projection of the liquid crystal layer 303 on the surface of the TFT array substrate 302 opposite to the liquid crystal layer 303, or the third area A3 is in a region of the liquid crystal layer 303, that is, a size of the third area A3 is less than a size of an area corresponding to the liquid crystal layer 303, the fourth area A2 is positioned at an outer side of the third area A3, and shading materials 301 are disposed on the fourth area A4. The shading materials 301 can be black glue or a black plastic, etc.

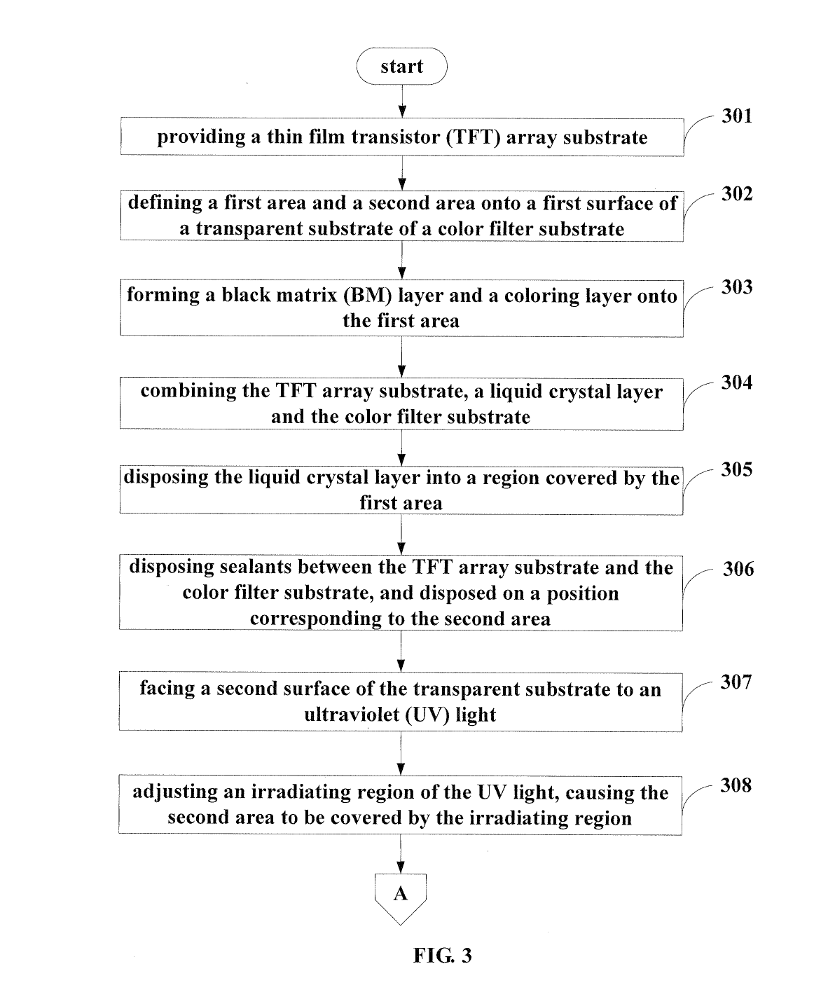

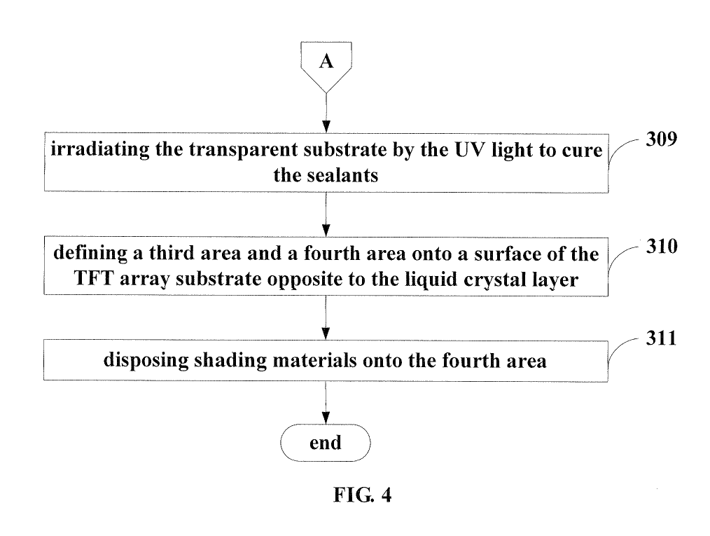

Please refer to FIGS. 3 and 4. FIGS. 3 and 4 are flow charts of a method according to the present invention for manufacturing the LCD panel. In the present invention, the LCD panel includes the TFT array substrate 302, the color filter substrate, the liquid crystal layer 303 and the frame.

In step 301, the TFT array substrate 302 is provided.

In step 302 to step 303, the color filter substrate is provided. The color filter substrate includes the transparent substrate 306, the BM layer 305 and the coloring layer 304. The transparent substrate 306 can be the glass substrate. The transparent substrate 306 has the first surface 3061 and the second surface 3062. Specifically, in step 302, the first area A1 and the second area A2 are defined on the first surface 3061 of the transparent substrate 306, and the second area A2 is positioned at the outer side of the first area A1. In step 303, the BM layer 305 and the coloring layer 304 are formed on the first area A1.

In step 304 to step 306, the TFT array substrate 302, the liquid crystal layer 303 and the color filter substrate are combined, and the sealants 307 is disposed between the TFT array substrate 302 and the color filter substrate. Specifically, in step 304, the TFT array substrate 302 and the color filter substrate are combined, and then liquid crystals are injected between the TFT array substrate 302 and the color filter substrate to form the liquid crystal layer 303. In step 305, the liquid crystal layer 303 is disposed between the TFT array substrate 302 and the color filter substrate. The first surface 3061 of the transparent substrate 306 is faced to the liquid crystal layer 303. Further, the liquid crystal layer 303 is disposed in a region covered by the first area A1. The first surface 3061 of the transparent substrate 306 is faced to the liquid crystal layer 303. In step 306, the sealants 307 is disposed between the TFT array substrate 302 and the color filter substrate, and disposed on the position corresponding to the second area A2, that is, the frame is disposed at the outer side edge of the liquid crystal layer 303.

In step 307 to step 309, the sealants 307 are irradiated by the UV light 10 to form the frame. Specifically, in step 307, the second surface 3062 of the transparent substrate 306 is faced to the UV light 10. In step 308, the irradiating region of the UV light 10 is adjusted, and causes the projecting region of the second area A2 of the transparent substrate 306 on the first surface 3061 to be covered by the irradiating region of the UV light 10. In step 309, the transparent substrate 306 is irradiated by the UV light 10. However, since the transparent substrate 306 is transparent, and therefore the UV light 10 is passed through the transparent substrate 306 to the sealants 307. However, since the color filter substrate having the BM layer 305 and the coloring layer 304 is faced to the UV light 10, and the transparent substrate 306 can be penetrated by the UV light 10, so that the UV light 10 is irradiated on the sealants 307 to cure the sealants 307. In addition, the BM layer 305 and the coloring layer 304 within the color filter substrate can be used as the UV mask, so that the BM layer 305 and the coloring layer 304 can block the UV light 10 for the liquid crystal layer 303, and the UV mask 201 can be omitted in the process. Therefore, the BM layer 305 and the coloring layer 304 disposed on the color filter substrate are close to the liquid crystal layer 303, that can make the distance D3 between the sealants 307 and an active area be as small as possible, as well as the liquid crystal layer 303 not be irradiated by the UV light 10.

In step 310 to step 311, the shading materials 301 are disposed on the surface of the TFT array substrate 302 opposite to the liquid crystal layer 303. Specifically, in step 310, the third area A3 and the fourth area A4 are defined on the surface of the TFT array substrate 302 opposite to the liquid crystal layer 303. The third area A3 is the projection of the liquid crystal layer 303 on the surface of the TFT array substrate 302 opposite to the liquid crystal layer 303. Or, the third area A3 is in the region of the liquid crystal layer 303, that is, the size of the third area A3 is less than the size of the area corresponding to the liquid crystal layer 303, and the fourth area A4 is positioned at the outer side of the third area A3. In step 311, the shading materials 301 are disposed on the fourth area A4. The shading materials 301 can be black glue or a black plastic, etc. Therefore, the light leak of the backlight can be prevented at the second area A2, so as to ensure display quality of the LCD panel. The step 310 and the step 311 can be integrated in the step 301.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display (LCD) panel, comprising:
a thin film transistor (TFT) array substrate;
a color filter substrate comprising a transparent substrate, a black matrix (BM) layer and a coloring layer, the transparent substrate having a first surface and a second surface, a first area and a second area being defined on the first surface, the second area being positioned at an outer side of the first area, and the BM layer and the coloring layer being disposed on the first area;
a liquid crystal layer disposed between the TFT array substrate and the color filter substrate, and the first surface of the transparent substrate being faced to the liquid crystal layer; and
a frame disposed between the TFT array substrate and the color filter substrate, and disposed on a position corresponding to the second area,
wherein the liquid crystal layer is adjacent to a surface of the color filter substrate having the BM layer and the coloring layer, and the frame is disposed at an outer side edge of the liquid crystal layer.

2. The LCD panel of claim 1, wherein the liquid crystal layer is disposed in a region of the first area.

3. The LCD panel of claim 2, wherein an irradiating region of an ultraviolet (UV) light on the second surface is greater than or equal to a projecting region of the second area on the second surface.

4. The LCD panel of claim 3, wherein the TFT array substrate comprises a third area and a fourth area, the third area is a projection of the liquid crystal layer on the TFT array substrate, the fourth area is positioned at an outer side of the third area, and shading materials are disposed on the fourth area.

5. A liquid crystal display (LCD) panel, comprising:
a thin film transistor (TFT) array substrate;
a color filter substrate comprising a transparent substrate, a black matrix (BM) layer and a coloring layer, the transparent substrate having a first surface and a second surface, a first area and a second area being defined on the first surface, the second area being positioned at an outer side of the first area, and the BM layer and the coloring layer being disposed on the first area;
a liquid crystal layer disposed between the TFT array substrate and the color filter substrate, and the first surface of the transparent substrate being faced to the liquid crystal layer; and
a frame disposed between the TFT array substrate and the color filter substrate, and disposed on a position corresponding to the second area.

6. The LCD panel of claim 5, wherein the liquid crystal layer is disposed in a region of the first area.

7. The LCD panel of claim 6, wherein an irradiating region of an ultraviolet (UV) light on the second surface is greater than or equal to a projecting region of the second area on the second surface.

8. The LCD panel of claim 7, wherein the TFT array substrate comprises a third area and a fourth area, the third area is a projection of the liquid crystal layer on the TFT array substrate, the fourth area is positioned at an outer side of the third area, and shading materials are disposed on the fourth area.

9. A method for manufacturing a liquid crystal display (LCD) panel, the LCD panel comprising a thin film transistor (TFT) array substrate, a color filter substrate, a liquid crystal layer and a frame, the method comprising steps of:
(A) providing the TFT array substrate;
(B) providing the color filter substrate, the color filter substrate comprising a transparent substrate, a black matrix (BM) layer and a coloring layer, the transparent substrate having a first surface and a second surface, a first area and a second area being disposed on the first surface, and the BM layer and the coloring layer being disposed on the first area;
(C) combining the TFT array substrate, the liquid crystal layer and the color filter substrate, and then disposing sealants between the TFT array substrate and the color filter substrate, the liquid crystal layer being disposed between the TFT array substrate and the color filter substrate, the second surface of the transparent substrate being faced to the liquid crystal layer, the sealants being disposed between the TFT array substrate and the color filter substrate, and disposed on a position corresponding to the second area; and
(D) irradiating the sealants from the second surface of the transparent substrate by an ultraviolet (UV) light to form the frame.

10. The method for manufacturing a LCD panel of claim 9, wherein the step (B) further comprises the following steps of:
(b1) defining the first area and the second area onto the first surface of the transparent substrate, and the second area being positioned at an outer side of the first area; and
(b2) forming the BM layer and the coloring layer onto the first area.

11. The method for manufacturing a LCD panel of claim 10, wherein the step (C) further comprises the following steps of:
(c1) disposing the liquid crystal layer into a region covered by the first area; and
(c2) disposing the sealants between the TFT array substrate and the color filter substrate, and disposed on the position corresponding to the second area.

12. The method for manufacturing a LCD panel of claim 11, wherein the step (D) further comprises the following steps of:
(d1) facing the second surface of the transparent substrate to the UV light;
(d2) adjusting an irradiating region of the UV light, causing the second area of the transparent substrate to be covered by the irradiating region of the UV light; and
(d3) irradiating the transparent substrate by the UV light.

13. The method for manufacturing a LCD panel of claim 12, wherein the method further comprises the following step of:
(E) disposing shading materials onto a surface of the TFT array substrate opposite to the liquid crystal layer.

14. The method for manufacturing a LCD panel of claim 13, wherein the step (E) further comprises the following steps of:
(e1) defining a third area and a fourth area onto the surface of the TFT array substrate opposite to the liquid crystal layer, and the fourth area being positioned at an outer side of the third area; and
(e2) disposing the shading materials onto the fourth area.
